(19) United States
(12) Patent Application Publication
(10) Pub. No.: US 2020/0061747 A1
(43) Pub. Date: Feb. 27, 2020

(54) TOOL WITH CUTTING EDGE AND METHOD OF MANUFACTURING IT

(71) Applicants: HANGZHOU GREAT STAR INDUSTRIAL CO., LTD., Hangzhou City, Zhejiang Province (CN); HANGZHOU GREAT STAR TOOLS CO., LTD., Hangzhou City, Zhejiang Province (CN)

(72) Inventor: Weiyi Wang, Hangzhou City, Zhejiang Province (CN)

(73) Assignees: HANGZHOU GREAT STAR INDUSTRIAL CO., LTD., Hangzhou City, Zhejiang Province (CN); HANGZHOU GREAT STAR TOOLS CO., LTD., Hangzhou City, Zhejiang Province (CN)

(21) Appl. No.: 16/344,089

(22) PCT Filed: Sep. 20, 2017
(86) PCT No.: PCT/CN2017/102517

§ 371 Date: Apr. 23, 2019

(51) Int. Cl. B23K 26/34; C23C 24/10; C21D 9/24; C21D 9/18

(52) U.S. Cl. CPC B23K 26/34; C23C 24/10; B26B 9/00; C21D 9/18; C21D 9/24

(57) ABSTRACT

The present invention discloses a method of manufacturing a tool with a cutting edge comprising a substrate for supporting and a cladding layer for forming the cutting edge, and a transition zone connecting the substrate and the cladding layer; the method of manufacturing it includes: providing a first material used for forming the substrate and having a first side; providing a second material which is clad onto the first side by way of laser cladding to form the cladding layer, and forming a transition zone between the cladding layer and the substrate where the first material and the second material are metallurgically bonded. The tool obtained by adopting the manufacturing process according to the present invention combines the following advantages: good toughness of the cutter body, high hardness of the cutting edge, not easy breaking off of the cutter body and the cutting edge, and long service life.

### FIELD OF THE INVENTION

The present invention relates to a tool with a cutting edge, and in particular, to a tool obtained by forming a cladding layer on the surface of the cutting edge by laser cladding treatment, providing the tool with both high hardness and high abrasion resistance of the cutting edge as well as high toughness of the cutter body or other portions. The present invention also relates to a method of manufacturing such a tool with a cutting edge.

### DESCRIPTION OF THE PRIOR ART

In order to cut or shear objects, people often use tools with a cutting edge, such as various cutters, aviation snips, pliers with blade edges and the likes. The traditional stainless-steel cutter (such as a single-edged cutter) generally use whole cast martensitic stainless steel (including but not limited to the following: 20Cr13, 30Cr13, 40Cr13, 50Cr15MoV, 68Cr17, 95Cr18, 90Cr18MoV, etc.) as a substrate, which goes through an overall heat treatment after blanking, and then is edged and assembled. If a single-edged cutter uses the whole cast low-carbon martensitic stainless steel (such as 20Cr13, 30Cr13, etc.), the substrate of such a single-edged cutter has good toughness, but a low hardness of the cutting edge and poor abrasion resistance, and the actual cutting life of the overall blade edges is short. But if a single-edged cutter uses whole cast high-carbon martensitic stainless steel (such as 95Cr18, 90Cr18MoV, etc.), the cutting edge thereof would have improved hardness and abrasion resistance, and the actual cutting life of the overall cutting edge is improved, but the blade overall has a greater brittleness and is easily broken if dropped, and the unit cost of the raw material of high-carbon martensitic stainless steel is high, and market competitiveness thereof is poor.

The traditional aviation snips generally use whole cast alloy structural steel, tool steel, spring steel (including but not limited to, 50CrMo, 6CrW2Si, 60Si2Mn, 60Si2Cr, 60Si2CrV, 60CrMn, etc.) as a substrate, which goes through an overall heat treatment after hot-forging, and then is edged and assembled. The aviation snips obtained by this method have a good impact resistance/toughness of the substrate thereof, but the abrasion resistance of the cutting edge thereof is poor, and the actual shearing life is short.

If the characteristics of the manufacturing material used is between high hardness and high toughness, only a balance between toughness of the substrate and hardness of the cutting edge of the cutter or aviation snips can be obtained, but neither of them achieves the best effect. Other tools with a cutting edge also have drawbacks similar to those of the cutter and aviation snips.

Hence, those skilled in the art are endeavoring to develop a tool with a cutting edge having both high hardness and high abrasion resistance of the cutting edge, as well as high toughness of the other portions and long service life, and a method of manufacturing it.

### SUMMARY OF THE INVENTION

In view of the above-mentioned drawbacks of the prior art, the technical problem to be solved by the present invention is to provide a tool with a cutting edge incorporating the advantages of high hardness and high abrasion resistance of the cutting edge, high toughness of other portions, and long service life, and a method of manufacturing it.

In order to achieve the above-mentioned object, an aspect of the present invention is to provide a method of manufacturing a tool with a cutting edge: the tool with a cutting edge includes a substrate for supporting and a cladding layer for forming the cutting edge, and a transition zone connecting the substrate and the cladding layer; the method of manufacturing includes: providing a first material used for forming the substrate and having a first side; providing a second material which is clad onto the first side by way of laser cladding to form a cladding layer, and forming the transition zone between the cladding layer and the substrate where the first material and the second material are metallurgically bonded.

In a specific implementation, the second material includes at least one compound selected from the group consisting of tungsten carbide, titanium carbide, chromium carbide, vanadium carbide, aluminum oxide and zirconium oxide, or includes carbon and at least one of the following four metal monomers: tungsten, titanium, chromium, vanadium; and the second material further includes nickel and/or cobalt.

Preferably, the second material includes at least one compound selected from the group consisting of tungsten carbide, titanium carbide, chromium carbide, vanadium carbide, aluminum oxide and zirconium oxide, or includes carbon and at least one of the following four metal monomers: tungsten, titanium, chromium, vanadium; and the second material further includes nickel and cobalt.

In another specific implementation, the second material includes at least one compound selected from the group consisting of tungsten carbide, titanium carbide, chromium carbide, vanadium carbide, aluminum oxide and zirconium oxide, and further includes carbon and at least one of the following four metal monomers: tungsten, titanium, chromium, vanadium, and further includes nickel and/or cobalt.

Preferably, the second material includes at least one compound selected from the group consisting of tungsten carbide, titanium carbide, chromium carbide, vanadium carbide, aluminum oxide and zirconium oxide, and further includes carbon and at least one of the following four metal monomers: tungsten, titanium, chromium, vanadium, and further includes nickel and cobalt.

Further, the carbon, the tungsten, the titanium, the chromium, and the vanadium are all powdered.

Further, the first material is quench-hardened steel.

Preferably, the first material includes one or more of martensitic stainless steel, alloy structural steel, tool steel and spring steel.

Further, the martensitic stainless steel is selected from the group consisting of 20Cr13, 30Cr13, 40Cr13, 50Cr15MoV, 68Cr17, 95Cr18, and 90Cr18MoV.

In a specific implementation, the first material is selected from the group consisting of 50CrMo, 6CrW2Si, 60Si2Mn, 60Si2Cr, 60Si2CrV, and 60CrMn.

Further, the laser cladding refers to melting, by using a laser device, the substances of the second material, which have a melting point lower than the temperature of a laser generated by the laser device at a set power of the laser device and at a set movement speed of the laser head, and carrying the substances having a melting point higher than the temperature of the laser to bond to the first side to form the cladding layer; and meanwhile the first side and the first material adjacent to the first side are melted under the action of the temperature of the laser, and are metallurgically bonded with the second material adjacent to the first side to form the transition zone.

Further, the substances of the second material having a melting point higher than the temperature of the laser are dispersively distributed in the cladding layer.

Preferably, the substances of the second material having a melting point higher than the temperature of the laser are evenly distributed in the cladding layer.

Further, the laser is a CO2 gas laser device, a YAG solid laser device, a fiber laser device, or a DIODE semiconductor laser device.

Further, the power of the laser device is ≥1000 W, and the movement speed of the laser head during cladding is 2.0-15.0 mm/s.

Further, the method of manufacturing further includes: vacuum quenching the tool blank after the laser cladding, the quenching temperature being 850-1250° C., and the quenching medium being quenching oil or inert gas; and vacuum tempering the tool blank after the quenching is completed, the tempering temperature being 200-600° C., and the soaking time being 2-8 hours.

Further, the method of manufacturing further includes: vacuum quenching the tool blank before the laser cladding, the quenching temperature being 850-1250° C., and quenching medium being quenching oil or inert gas; and vacuum tempering the tool blank after the quenching is completed, the tempering temperature being 200-600° C., and the soaking time being 2-8 hours.

Further, the method of manufacturing further includes: grinding the cutting edge for the tool blank after the laser cladding, the quenching, and the tempering; assembling and packaging.

Further, the cladding layer has a hardness 10 HRC or more higher than that of the substrate.

Another aspect of the present invention is to provide a tool with a cutting edge, including a substrate for supporting and a cladding layer for forming the cutting edge, and a transition zone connecting the substrate and the cladding layer; the substrate is comprised of a first material, the first material being hardened stainless steel and having a first side; the cladding layer is comprised of a second material comprising at least one compound selected from the group consisting of tungsten carbide, titanium carbide, chromium carbide, vanadium carbide, aluminum oxide and zirconium oxide, or includes carbon and at least one of the following four metal monomers: tungsten, titanium, chromium, vanadium; and the second material further includes nickel and/or cobalt; the transition zone is a region formed between the cladding layer and the substrate where the first material and the second material are metallurgically boned while the second material is clad onto the first side by way of laser cladding to form the cladding layer.

Further, the carbon, the tungsten, the titanium, the chromium, and the vanadium are all powdered.

Further, the cladding layer has a depth of 0.2-6.0 mm, preferably 1.0-3.0 mm.

Further, the cladding layer has a first edge for cutting or shearing, and the first edge is smooth or serrated.

Further, the tool with a cutting edge is manufactured by adopting the method of manufacturing the tool with a cutting edge as described above.

Further, the tool with a cutting edge is a cutter, a saw, an ax, aviation snips, or pliers with a cutting edge.

In a specific implementation, the second material further includes nickel and cobalt.

In another specific implementation, the second material includes at least one compound selected from the group consisting of tungsten carbide, titanium carbide, chromium carbide, vanadium carbide, aluminum oxide and zirconium oxide, and further includes carbon and at least one of the following four metal monomers: tungsten, titanium, chromium, vanadium.

In yet another specific implementation, the second material includes at least one compound selected from the group consisting of tungsten carbide, titanium carbide, chromium carbide, vanadium carbide, aluminum oxide and zirconium oxide, and further includes carbon and at least one of the following four metal monomers: tungsten, titanium, chromium, vanadium, and further includes nickel and cobalt.

Further, the first material includes one or more of martensitic stainless steel, alloy structural steel, tool steel and spring steel.

Further, the laser cladding refers to melting, by using a laser device, the substances of the second material, which have a melting point lower than the temperature of the laser generated by the laser device at a set power of the laser device and at a set movement speed of the laser head, and carrying the substances having a melting point higher than the temperature of the laser to bond to the first side to form the cladding layer; and meanwhile the first side and the first material adjacent to the first side are melted under the action of the temperature of the laser, and are metallurgically bonded with the second material adjacent to the first side to form a transition zone; the substances of the second material having a melting point higher than the temperature of the laser are dispersively distributed in the cladding layer.

Further, the cladding layer has a hardness 10HRC or more higher than that of the substrate.

For the tool with a cutting edge according to the present invention, the substrate for supporting thereof has good toughness, and the cladding layer for forming the cutting edge thereof has high hardness and high abrasion resistance. The metallurgical structures of the cladding layer, the transition zone and the substrate near the transition zone, obtained using the first material and the second material and the laser cladding method in the present invention, have no holes, which indicates that both the effect of the laser cladding and the effect of connecting are good, and therefore the transition zone has relatively high strength and is not easy to be broken; the strong tensile strength of the substrate is remained; and carbide particles having high hardness and high abrasion resistance are distributed in the cladding layer, which enhances the hardness and abrasion resistance of the cutting edge so that the cutting edge are more durable in use.

For the tool with a cutting edge obtained by the metal materials and the process method according to the present invention, the cutter body thereof has a hardness of 48-54 HRC, the cutting edge thereof has a hardness of 60-70 HRC, and the hardness of the cladding layer is increased by more than 10 HRC compared with that of the substrate, and the hardness of the tool is increased on average by 15 HRC. Since the tool combines high toughness of the supporting portion and high hardness and high abrasion resistance of the cutting edge portion, the durability thereof is more than 240 mm, which greatly improves the service life of the tool.

In addition, the use of both nickel and cobalt in the second material is advantageous for better solid-liquid combination. During the laser cladding, the substances of the second material, which have a melting point lower than the temperature of the laser, are melted into liquid state, and the substances having a melting point higher than the temperature of the laser keep a solid powdered structure. If the substances melted into liquid state and the non-melted solid powder particles can be better combined, it facilitates even distribution of the non-melted solid powder particles having high hardness and high abrasion resistance in the cladding layer. Since nickel and cobalt are different metal elements, their melting point is lower than the temperature of the laser, the mixture when melted into liquid is easier to wet the solid than a single liquid, that is, the resulting wetting angle is smaller, and the smaller the wetting angle is, the better the solid-liquid combination is, thereby making the solid-liquid combination better.

Secondly, the second material includes carbon and at least one of the following four metal monomers: tungsten, titanium, chromium, vanadium, which also facilitates even distribution or dispersive distribution of the powder particles having high hardness and high abrasion resistance in the cladding layer, and thus improving the overall hardness and abrasion resistance of the cutting edge. The even distribution of the powder particles having high hardness and high abrasion resistance is constrained by two conditions: one is the size of the particles; the other is the mixing condition. The larger the particles are, the less likely they are to be evenly distributed. If carbide is produced by the reaction of carbons with metal monomers during the laser cladding (for example, tungsten carbide is produced by the reaction of carbon powder with tungsten power during melting), the carbide is produced on the molecular level, thereby making the particles of the carbide smaller than that of the finished carbide product which is directly added. The particle size of the finished carbide product is limited by the particle size of the product on the market, and it is not easily controlled compared to the particle size of the carbide produced by a separate reaction during the laser cladding. Thus, the second material includes carbon and at least one of the following four metal monomers: tungsten, titanium, chromium, vanadium, and the reaction is driven to produce the carbide by the laser cladding process, so as to allow the carbide in the second material to be more evenly distributed.

The concepts, the specific structures and the technical effects of the present invention will be described further below in conjunction with the accompanying drawings, in order to fully understand the objects, features and effects of the present invention.

### BRIEF DESCRIPTION OF THE DRAWINGS

FIG. 1 is a schematic structural view of a preferred embodiment of the present invention, which is specifically a single-edged cutter.

FIG. 2 is a schematic cross-sectional view of FIG. 1 taken along line AA.

FIG. 3 is a schematic structural view of another embodiment of the present invention, which are specifically aviation snips.

FIG. 4 is a schematic structural view of yet another embodiment of the present invention, which are specifically pliers with a cutting edge.

FIG. 5 is a metallographic picture of an embodiment of the tool with a cutting edge according to the present invention, showing the metallographic structures of the substrate, the transition zone and the cladding layer, with a magnification of 100 times.

FIG. 6 is a metallographic picture of a zone in FIG. 5 with a magnification of 400 times.

### DETAILED DESCRIPTION OF THE PREFERRED EMBODIMENTS

The tool with a cutting edge as defined in the present invention is used for cutting and/or shearing objects, includes a substrate, a cladding layer, and a transition zone connecting the substrate and the cladding layer. The substrate plays a role in supporting the cutting edge; the cutting edge can be used for cutting and/or shearing, and may be formed by grinding the blade edges after heat treatment of the cladding layer.

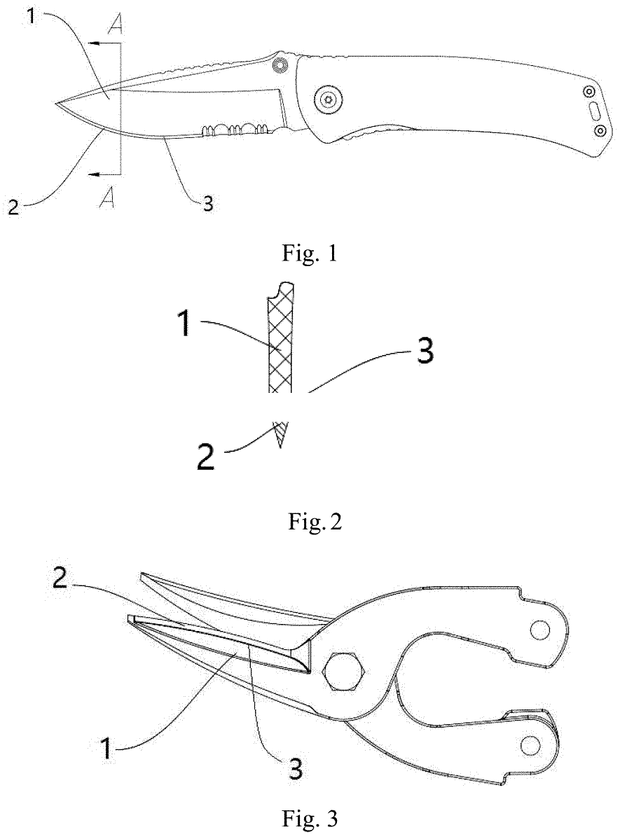

FIG. 1 shows an embodiment of the present invention, which is a single-edged cutter. FIG. 2 shows a schematic view of the single-edged cutter taken along line AA. The single-edged cutter includes a substrate 1 for supporting, a cladding layer 2 for forming the cutting edge, and a transition zone 3 connecting the substrate 1 and the cladding layer 2. The substrate 1 is made of a first material and has a first side. The cladding layer 2 is made of a second material and is formed by cladding the second material onto the first side by way of laser cladding. Also formed is a transition zone 3 between the cladding layer 2 and the substrate 1. The transition zone 3 is a zone where the first material and the second material are metallurgically boned. The depth of the cladding layer 2 is between 0.2 and 6.0 mm, preferably between 1.0 and 3.0 mm.

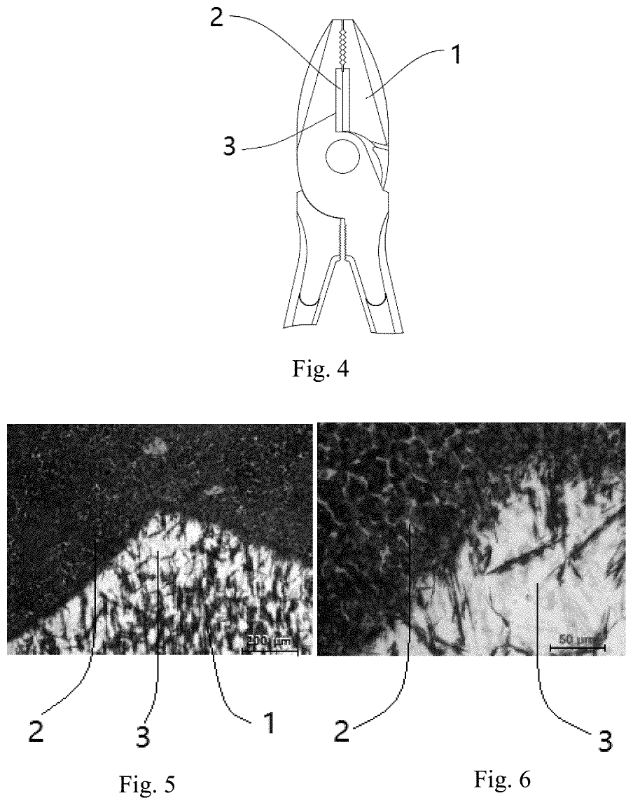

It will be appreciated by those skilled in the art that the tool with a cutting edge according to the present invention may have a variety of shapes and configurations, for example, aviation snips as shown in FIG. 3, and pliers with a cutting edge as shown in FIG. 4. Similar to the single-edged cutter as shown in FIGS. 1 and 2, each of them has a substrate 1, a cladding layer 2 and a transition zone 3. Furthermore, the tool with a cutting edge according to the present invention may also be other cutters, saws, axes, and will not be described again here. The cladding layer has a first edge for cutting or shearing, the first edge is smooth or serrated. For example, the first edge is smooth when it is a single-edged cutter; and the first edge is serrated when it is a saw.

The first material is quench-hardened steel, and most preferred is steel having relatively high toughness, such as one or more of martensitic stainless steel, alloy structural steel, tool steel and spring steel. In a preferred embodiment, the martensitic stainless steel is selected from the group consisting of the standardized martensitic stainless steel with the following grades (Chinese grade): 20Cr13, 30Cr13, 40Cr13, 50Cr15MoV, 68Cr17, 95Cr18, 90Cr18MoV, etc. In another preferred embodiment, the first material is selected from the group consisting of 50CrMo, 6CrW2Si, 60Si2Mn, 60Si2Cr, 60Si2CrV and 60CrMn.

The second material has relatively high hardness and/or abrasion resistance. In a preferred embodiment, the second material is at least one compound selected from the group consisting of tungsten carbide, titanium carbide, chromium carbide, vanadium carbide, aluminum oxide and zirconium oxide, and the second material further includes nickel or cobalt. In yet another preferred embodiment, the second material is at least one compound selected from the group consisting of tungsten carbide, titanium carbide, chromium carbide, vanadium carbide, aluminum oxide and zirconium oxide, and the second material further includes nickel and cobalt. In a third preferred embodiment, the second material includes carbon and at least one of the following four metal monomers: tungsten, titanium, chromium, vanadium, and the second material further includes nickel or cobalt. In a fourth preferred embodiment, the second material includes carbon and at least one of the following four metal monomers: tungsten, titanium, chromium, vanadium, and the second material further includes nickel and cobalt. In a fifth preferred embodiment, the second material includes at least one compound selected from the group consisting of tungsten carbide, titanium carbide, chromium carbide, vanadium carbide, aluminum oxide and zirconium oxide, and further includes carbon and at least one of the following four metal monomers: tungsten, titanium, chromium, vanadium, and further includes nickel or cobalt. In a sixth preferred embodiment, the second material includes at least one compound selected from the group consisting of tungsten carbide, titanium carbide, chromium carbide, vanadium carbide, aluminum oxide and zirconium oxide, and further includes carbon and at least one of the following four metal monomers: tungsten, titanium, chromium, vanadium, and further includes nickel and cobalt. All of the substances of the above-mentioned second material are granular (they are powdered when they are fine granules).

Another aspect of the present invention provides a method of manufacturing a tool with a cutting edge as described above, and in a specific implementation, the method of manufacturing includes the steps of: 1) blanking the first material in accordance with the tool size to obtain a substrate with a first side; 2) cladding the second material onto the first side by way of laser cladding to form a cladding layer made of a second material, and a transition zone is formed between the cladding layer and the substrate where the first material and the second material are metallurgically bonded; 3) quenching and tempering; 4) grinding the blade edges; 5) assembling and packaging.

First, the first material is blanked and cut into a shape substantially corresponding to the substrate of the finished tool with a cutting edge. The cutting may be carried out using a wire cutting or a high-speed punch, or may be carried out using other cutting methods conventionally used in the art. The first material after cutting has a relatively flat first side.

Then, a laser cladding operation is performed using a CO2 gas laser device, a YAG solid laser device, a fiber laser device, or a DIODE semiconductor laser device. The power of the laser device is not less than 1000 W, and the movement speed of the laser head during cladding is 2.0-15.0 mm/s; and a layer of the second material is clad onto the first side of the first material after cutting to form a cladding layer, and a transition zone is formed between the cladding layer and the substrate which includes both the first material and the second material. In the transition zone, the first material and the second material are fused together, i.e., are metallurgically bonded.

Thereafter, the tool blank after the laser cladding is subjected to overall quenching and overall tempering. Both the quenching and tempering are performed in a vacuum furnace. The quenching temperature is between 850 and 1250° C., and the quenching medium can be quenching oil and also can be inert gas. As a preferred option, the quenching medium is nitrogen. After the quenching is completed, the tool blank is vacuum tempered in the vacuum furnace, the tempering temperature is between 200 and 600° C., and the soaking time is 2-8 hours.

Finally, the tool blank after the quenching and tempering is ground in size and shape, especially grinding the cutting edge. The grinding may be carried out using the methods conventionally used in the art, for example by means of a grinder.

In another specific implementation of the method of manufacturing according to the present invention, it further includes quenching and tempering the substrate formed in step 1 before the laser cladding operation. The remaining steps are the same as those of the previous specific implementation and will not be described again here.

In yet another specific implementation of the method of manufacturing according to the present invention, it further includes obtaining a substrate with a first side which has a certain shape by hot forging after the first material is blanked in accordance with the tool size. The remaining steps are the same as those of the previous specific implementation and will not be described again here.

The metallographic structures of the substrate 1, the cladding layer 2, and the transition zone 3 obtained by the method of manufacturing according to the above-mentioned specific implementations or embodiments have substantially no holes (as shown in FIGS. 5 and 6), which indicates that the laser cladding in the specific implementations can bond the first material with the second material well so as to ensure both high toughness of the substrate and high hardness and high abrasion resistance of the cladding layer, and to ensure that the transition zone connects the substrate and the cladding layer closely.

After the laser cladding, quenching, and tempering treatments, the substrate has a hardness of 48-54 HRC, such hardness imparts good toughness to the substrate, making the substrate not easy to be broken. The cladding layer has a hardness of 60-70 HRC, which imparts good abrasion resistance to the cladding layer, making the service life of the cutting edge longer.

### Embodiment 1 a Single-Edged Cutter

1) Blanking the first material in accordance with the tool size to obtain a substrate with a first side. The first material is martensitic stainless steel. Then, a first quenching and a first tempering are performed in a vacuum furnace. The quenching temperature is between 850 and 1250° C., and the quenching medium is nitrogen. The tempering is performed after the quenching is completed, the tempering temperature is between 200 and 600° C., and the soaking time is 2-8 hours.

2) Using a DIODE semiconductor laser device, and the power of the laser device is not less than 1000 W, the laser head performs a laser cladding operation with the movement speed of between 2.0 and 15.0 mm/s during cladding. The second material is clad onto the first side to form a cladding layer made of the second material, and a transition zone is formed between the cladding layer and the substrate where the first material and the second material are metallurgically bonded. The second material includes carbon and at least one of the following four metal monomers: tungsten, titanium, chromium, vanadium, and the second material further includes both nickel and cobalt. The substances of the second material are all powdered.

3) Performing a second quenching and a second tempering in the vacuum furnace. The quenching temperature is between 850 and 1250° C., and the quenching medium is nitrogen. The tempering is performed after the quenching is completed, the tempering temperature is between 200 and 600° C., and the soaking time is 2-8 hours.

4) Grinding the blade edges.

5) Assembling and packaging to obtain a single-edged cutter according to Embodiment 1.

The methods of manufacturing the single-edged cutters according to Embodiments 2 to 6 are the same as that of the single-edged cutter according to Embodiments 1 except for the differences listed in Table 1.

### Table 1 Embodiments 2 to 6 of the Single-Edged Cutters

TABLE 1

| | Differences from Embodiment 1 |
|---|---|
| Embodiment 2 | In Step 2), in addition to carbon and at |
| | least one of the following four metal |
| | monomers: tungsten, titanium, chromium, |
| | vanadium, the second material only |
| | includes nickel and does not include |
| | cobalt. |
| Embodiment 3 | In Step 2), in addition to carbon and at |
| | least one of the following four metal |
| | monomers: tungsten, titanium, chromium, |
| | vanadium, the second material only |
| | includes cobalt and does not include |
| | nickel. |
| Embodiment 4 | In Step 2), the second material includes at |
| | least one compound selected from the |
| | group consisting of tungsten carbide, |
| | titanium carbide, chromium carbide, |
| | vanadium carbide, aluminum oxide and |
| | zirconium oxide, and includes both nickel |
| | and cobalt. |
| Embodiment 5 | In Step 2), the second material includes at |
| | least one compound selected from the |
| | group consisting of tungsten carbide, |
| | titanium carbide, chromium carbide, |
| | vanadium carbide, aluminum oxide and |
| | zirconium oxide, and only includes nickel |
| | and does not include cobalt. |
| Embodiment 6 | In Step 2), the second material includes at |
| | least one compound selected from the |
| | group consisting of tungsten carbide, |
| | titanium carbide, chromium carbide, |
| | vanadium carbide, aluminum oxide and |
| | zirconium oxide, and only includes cobalt |
| | and does not include nickel. |

### Embodiment 7 a Single-Edged Cutter

1) Blanking the first material in accordance with the tool size to obtain a substrate with a first side. The first material is martensitic stainless steel.

2) Using a DIODE semiconductor laser device, the power of the laser device is not less than 1000 W, the laser head performs a laser cladding operation with the movement speed of between 2.0 and 15.0 mm/s during cladding. The second material is clad onto the first side to form a cladding layer made of the second material, and a transition zone is formed between the cladding layer and the substrate where the first material and the second material are metallurgically bonded. The second material includes at least one compound selected from the group consisting of tungsten carbide, titanium carbide, chromium carbide, vanadium carbide, aluminum oxide and zirconium oxide, and the second material further includes nickel and cobalt. The substances of the second material are all powdered.

3) Performing quenching and tempering in a vacuum furnace. The quenching temperature is between 850 and 1250° C., and the quenching medium is quenching oil. The tempering is performed after the quenching is completed, the tempering temperature is between 200 and 600° C., and the soaking time is 2-8 hours.

4) Grinding the blade edges.

5) Assembling and packaging to obtain a single-edged cutter according to Embodiment 7

The methods of manufacturing the single-edged cutters according to Embodiments 8 to 12 are the same as that of the single-edged cutter according to Embodiments 7 except for the differences listed in Table 2.

### Table 2 Embodiments 8 to 12 of the Single-Edged Cutters

TABLE 2

| | Differences from Embodiment 7 |
|---|---|
| Embodiment 8 | In Step 2), the second material includes |
| | carbon and at least one of the following |
| | four metal monomers: tungsten, titanium, |
| | chromium, vanadium, and includes both |
| | nickel and cobalt. |
| Embodiment 9 | In Step 2), the second material includes |
| | carbon and at least one of the following |
| | four metal monomers: tungsten, titanium, |
| | chromium, vanadium, and only includes |
| | nickel and does not include cobalt. |
| Embodiment 10 | In step 2), the second material includes |
| | carbon and at least one of the following |
| | four metal monomers: tungsten, titanium, |
| | chromium, vanadium, and only includes |
| | cobalt and does not include nickel. |
| Embodiment 11 | In Step 2), in addition to at least one |
| | compound selected from the group |
| | consisting of tungsten carbide, titanium |
| | carbide, chromium carbide, vanadium |
| | carbide, aluminum oxide and zirconium |
| | oxide, the second material only includes |
| | nickel and does not include cobalt. |
| Embodiment 12 | In Step 2), in addition to at least one |
| | compound selected from the group |
| | consisting of tungsten carbide, titanium |
| | carbide, chromium carbide, vanadium |
| | carbide, aluminum oxide and zirconium |
| | oxide, the second material only includes |
| | cobalt and does not include nickel. |

### Embodiment 13: Aviation Snips

1) Blanking the first material in accordance with the tool size and hot forging to obtain a substrate with a first side. The first material is raw material such as alloy structural steel, tool steel, spring steel: bar material. Then, a first quenching and a first tempering are performed in a vacuum furnace. The quenching temperature is between 850 and 1250° C., and the quenching medium is nitrogen. The tempering is performed after the quenching is completed, the tempering temperature is between 200 and 600° C., and the soaking time is 2-8 hours.

2) Using a DIODE semiconductor laser device, and the power of the laser device is not less than 1000 W, the laser head performs a laser cladding operation with the movement speed of between 2.0 and 15.0 mm/s during cladding. The second material is clad onto the first side to form a cladding layer made of the second material, and a transition zone is formed between the cladding layer and the substrate where the first material and the second material are metallurgically bonded. The second material includes at least one compound selected from the group consisting of tungsten carbide, titanium carbide, chromium carbide, vanadium carbide, aluminum oxide and zirconium oxide, and the second material further includes nickel and cobalt.

3) Performing a second quenching and a second tempering in the vacuum furnace. The quenching temperature is between 850 and 1250° C., and the quenching medium is nitrogen. The tempering is performed after the quenching is completed, the tempering temperature is between 200 and 600° C., and the soaking time is 2-8 hours.

4) Grinding the blade edges.

5) Assembling and packaging to obtain the aviation snips according to Embodiment 13.

### Embodiment 14 Pliers with a Cutting Edge

1) Blanking the first material in accordance with the tool size and hot forging to obtain a substrate with a first side. The first material is alloy structural steel. Then, a first quenching and a first tempering are performed in a vacuum furnace. The quenching temperature is between 850 and 1250° C., and the quenching medium is nitrogen. The tempering is performed after the quenching is completed, the tempering temperature is between 200 and 600° C., and the soaking time is 2-8 hours.

2) Using a CO2 gas laser device, the power of the laser device is not less than 1000 W, the laser head performs a laser cladding operation with the movement speed of between 2.0 and 15.0 mm/s during cladding. The second material is clad onto the first side to form a cladding layer made of the second material, and a transition zone is formed between the cladding layer and the substrate where the first material and the second material are metallurgically bonded. The second material includes carbon and at least one of the following four metal monomers: tungsten, titanium, chromium, vanadium, and the second material further includes nickel or cobalt.

3) Performing a second quenching and a second tempering in the vacuum furnace. The quenching temperature is between 850 and 1250° C., and the quenching medium is nitrogen. The tempering is performed after the quenching is completed, the tempering temperature is between 200 and 600° C., and the soaking time is 2-8 hours.

4) Grinding the blade edges.

5) Assembling and packaging to obtain the pliers with a cutting edge of Embodiment 14.

Compared to the existing single-edged cutters, the test stroke is 20 mm, and 60 cycles are tested, the single-edged cutters with the blade manufactured using the methods according to the present invention have the sharpness and durability as shown in Table 3:

### Table 3: Sharpness and Durability of Each Single-Edged Cutter

TABLE 3

| Serial | | | |
|---|---|---|---|
| number | Item | Sharpness (mm) | Durability (mm) |
| 1 | Single-edged | 56-66 | 300-333 |
| | cutters according to | | |
| | Embodiments 1 | | |
| | and 8 | | |
| 2 | Single-edged | 43-53 | 235-255 |
| | cutters according to | | |
| | Embodiments 2, 3, | | |
| | 9 and 10 | | |
| 3 | Single-edged | 50-60 | 242-273 |
| | cutters according to | | |
| | Embodiments 4 | | |
| | and 7 | | |
| 4 | Single-edged | 32-42 | 186-216 |
| | cutters according to | | |
| | Embodiments 5, 6, | | |
| | 11 and 12 | | |
| 5 | Existing | 30.7 | 109.3 |
| | single-edged cutter | | |
| | (50Cr15MoV | | |
| | whole cast blade) | | |
| 6 | Existing | 24.3 | 77.6 |
| | single-edged cutter | | |
| | (30Cr13 whole cast | | |
| | blade) | | |

It can be seen that both the sharpness and durability of the tools with a cutting edge according to embodiments of the present invention (with a single-edged cutter as an example) are improved relative to the blade of the existing single-edged cutter. Wherein, the use of both nickel and cobalt (for example, Embodiments 1, 4, 7 and 8) makes the sharpness increased by about 1 time and the durability increased by 2 to 3 times; the use of both nickel and cobalt and the use of carbon and at least one of the following four metal monomers: tungsten, titanium, chromium, vanadium, produce carbide during laser cladding (for example, Embodiments 1 and 8), the sharpness and durability thereof are the highest.

The 50Cr15MoV whole cast blade refers to a whole cast blade that the material of the substrate is 50Cr15MoV, and the blade is not subject to laser cladding process and has no cladding layer or transition layer, and the substrate is used for both supporting and forming the cutting edge. The 30Cr13 whole cast blade refers to a whole cast blade that the material of the substrate is 30Cr13, and the blade is not subject to laser cladding process and has no cladding layer or transition layer, and the substrate is used for both supporting and forming the cutting edge.

The preferred specific embodiments of the present invention have been described in detail above. It is to be understood that numerous modifications and variations can be made by those ordinary skilled in the art in accordance with the concepts of the present invention without any inventive effort. Hence, the technical solutions that can be derived by those skilled in the art according to the concepts of the present invention on the basis of the prior art through logical analysis, reasoning and limited experiments should be within the scope of protection defined by the claims.

1. A method of manufacturing a tool with a cutting edge, wherein:
the tool with a cutting edge comprises a substrate for supporting and a cladding layer for forming the cutting edge, and a transition zone connecting the substrate and the cladding layer;
the method of manufacturing comprises:
providing a first material used for forming the substrate and having a first side;
providing a second material which is clad onto the first side by way of laser cladding to form a cladding layer, and
forming the transition zone between the cladding layer and the substrate where the first material and the second material are metallurgically bonded.

2. The method of manufacturing a tool with a cutting edge according to claim 1, wherein the second material comprises at least one compound selected from the group consisting of tungsten carbide, titanium carbide, chromium carbide, vanadium carbide, aluminum oxide and zirconium oxide, or comprises carbon and at least one of the following four metal monomers: tungsten, titanium, chromium, vanadium; the second material further comprises nickel and/or cobalt.

3. The method of manufacturing a tool with a cutting edge according to claim 1, wherein the second material comprises at least one compound selected from the group consisting of tungsten carbide, titanium carbide, chromium carbide, vanadium carbide, aluminum oxide and zirconium oxide, or comprises carbon and at least one of the following four metal monomers: tungsten, titanium, chromium, vanadium; the second material further comprises nickel and cobalt.

4. The method of manufacturing a tool with a cutting edge according to claim 1, wherein the second material comprises at least one compound selected from the group consisting of tungsten carbide, titanium carbide, chromium carbide, vanadium carbide, aluminum oxide and zirconium oxide, and further comprises carbon and at least one of the following four metal monomers: tungsten, titanium, chromium, vanadium, and further comprises nickel and/or cobalt.

5. The method of manufacturing a tool with a cutting edge according to claim 1, wherein the second material comprises at least one compound selected from the group consisting of tungsten carbide, titanium carbide, chromium carbide, vanadium carbide, aluminum oxide and zirconium oxide, and further comprises carbon and at least one of the following four metal monomers: tungsten, titanium, chromium, vanadium, and further comprises nickel and cobalt.

6. The method of manufacturing a tool with a cutting edge according to claim 2, wherein the carbon, the tungsten, the titanium, the chromium, and the vanadium are all powdered.

7. The method of manufacturing a tool with a cutting edge according to claim 1, wherein the first material is quench-hardened steel.

8. The method of manufacturing a tool with a cutting edge according to claim 1, wherein the first material comprises one or more of martensitic stainless steel, alloy structural steel, tool steel and spring steel.

9. The method of manufacturing a tool with a cutting edge according to claim 8, wherein the martensitic stainless steel is selected from the group consisting of 20Cr13, 30Cr13, 40Cr13, 50Cr15MoV, 68Cr17, 95Cr18 and 90Cr18MoV.

10. The method of manufacturing a tool with a cutting edge according to claim 1, wherein the first material is selected from the group consisting of 50CrMo, 6CrW2Si, 60Si2Mn, 60Si2Cr, 60Si2CrV and 60CrMn.

11. The method of manufacturing a tool with a cutting edge according to claim 1, wherein the laser cladding refers to melting, by using a laser device, the substances of the second material, which have a melting point lower than the temperature of a laser generated by the laser device at a set power of the laser device and at a set movement speed of the laser head, and carrying the substances having a melting point higher than the temperature of the laser to bond to the first side to form the cladding layer; and meanwhile the first side and the first material adjacent to the first side are melted under the action of the temperature of the laser, and are metallurgically bonded with the second material adjacent to the first side to form the transition zone.

12. The method of manufacturing a tool with a cutting edge according to claim 11, wherein the substances of the second material having a melting point higher than the temperature of the laser are dispersively distributed in the cladding layer.

13. The method of manufacturing a tool with a cutting edge according to claim 11, wherein the substances of the second material having a melting point higher than the temperature of the laser are evenly distributed in the cladding layer.

14. (canceled)

15. The method of manufacturing a tool with a cutting edge according to claim 11, wherein the power of the laser device is ≥1000 W, and the movement speed of the laser head during cladding is 2.0-15.0 mm/s.

16. The method of manufacturing a tool with a cutting edge according to claim 1, wherein the method of manufacturing further comprises:
vacuum quenching the tool blank after the laser cladding, the quenching temperature being 850-1250° C., and the quenching medium being quenching oil or inert gas; and
vacuum tempering the tool blank after the quenching is completed, the tempering temperature being 200-600° C., and the soaking time being 2-8 hours.

17. The method of manufacturing a tool with a cutting edge according to claim 1, wherein the method of manufacturing further comprises:
vacuum quenching the tool blank before the laser cladding, the quenching temperature being 850-1250° C., and quenching medium being quenching oil or inert gas; and
vacuum tempering the tool blank after the quenching is completed, the tempering temperature being 200-600° C., and the soaking time being 2-8 hours.

18. (canceled)

19. A tool with a cutting edge, comprising a substrate for supporting and a cladding layer for forming the cutting edge, and a transition zone connecting the substrate and the cladding layer;
the substrate is comprised of a first material, the first material being hardened stainless steel and having a first side;
the cladding layer is comprised of a second material comprising at least one compound selected from the group consisting of tungsten carbide, titanium carbide, chromium carbide, vanadium carbide, aluminum oxide and zirconium oxide, or comprises carbon and at least one of the following four metal monomers: tungsten, titanium, chromium, vanadium; the second material further comprises nickel and/or cobalt;
the transition zone is a region formed between the cladding layer and the substrate where the first material and the second material are metallurgically boned while the second material is clad onto the first side by way of laser cladding to form the cladding layer.

20. (canceled)

21. The tool with a cutting edge according to claim 19, wherein the cladding layer has a first edge for cutting or shearing, the first edge being smooth or serrated.

22. The tool with a cutting edge according to claim 19, wherein the tool with a cutting edge is manufactured by adopting the method of manufacturing a tool with a cutting edge according to claim 1.

23. The tool with a cutting edge according to claim 19, wherein the tool with a cutting edge is a cutter, a saw, an ax, aviation snips, or pliers with a cutting edge.
